(19) United States
(12) Patent Application Publication
(10) Pub. No.: US 2013/0093814 A1
(43) Pub. Date: Apr. 18, 2013

(54) SELF CLEANING PRINTHEAD

(71) Applicants: Peter Michael Gulvin, Webster, NY (US); Varun Sambhy, Penfield, NY (US); Hong Zhao, Webster, NY (US); Kock-Yee Law, Penfield, NY (US); James M. Casella, Webster, NY (US)

(72) Inventors: Peter Michael Gulvin, Webster, NY (US); Varun Sambhy, Penfield, NY (US); Hong Zhao, Webster, NY (US); Kock-Yee Law, Penfield, NY (US); James M. Casella, Webster, NY (US)

(73) Assignee: XEROX CORPORATION, Norwalk, CT (US)

(21) Appl. No.: 13/275,245

(22) Filed: Oct. 17, 2011

(51) Int. Cl. B41J 2/165; B32B 37/12; B32B 38/04; B41J 2/135

(52) U.S. Cl. 347/33; 347/45; 347/35; 156/60; 156/272.8; 156/331.7

(57) ABSTRACT

A printhead has a nozzle plate, having an array of nozzles through which ink is expelled, a low adhesion, oleophobic polymer coating on a front face of the nozzle plate. A printer has a source of solid ink, a heater arranged to-heat the solid ink and convert it to liquid ink, and a printhead, the printhead having a nozzle plate, having an of nozzles through which ink is expelled, a low adhesion, oleophobic polymer coating on a front face of the nozzle plate, the coating selected to dispel the liquid ink prior to the liquid ink returning to solid form, and a wiper positioned to wipe the front face of the nozzle plate.

### CROSS-REFERENCE TO RELATED APPLICATIONS

Copending application U.S. Ser. No. 12/625,442, filed Nov. 24, 2009, entitled “COATING FOR AN INK JET PRINTHEAD FRONT FACE,” Xerox Ref. 20090325-US-NP;

Copending application U.S. Ser. No. 12/860,660, filed Aug. 20, 2010, entitled “THERMALLY STABLE OLEOPHOBIC LOW ADHESION COATING FOR INKJET PRINTHEAD FRONT FACE,” Xerox Ref. 20100120-US-NP′

Copending application U.S. Ser. No. 13/______, filed simultaneously with this application, entitled, “IMPROVED PROCESS FOR THERMALLY STABLE OLEOPHOBIC LOW ADHESION COATING FOR INKJET PRINTHEAD FRONT FACE,” Xerox Ref. No. 20101641, the disclosure of each is incorporated herein by reference in their entirety.

### BACKGROUND

Ink jet printers may include arrays of apertures or nozzles on a final plate in a stack of plates used to route ink. Discussions here will refer to the stack of plates as the jetstack and the final plate as the nozzle plate. These nozzles may drool, meaning that they drip ink onto the front face of the printhead. This ink may then adhere to or block other nozzles causing them not to fire or misdirect the ink from them.

Current solutions to this problem include an active blade cleaning that uses ink purges and wiper blades to wipe off ink that collects on the front face. These blades typically come into play when missing nozzles are detected or after a power-down, when the ink has solidified, shrinking into the printhead drawing air into the system. The printer then purges ink to expel the contamination and trapped air, and clear the nozzles. The wiper blades wipe the ink and contamination off the front face.

Previously, solid ink printers went into a low power state when not used, such as at night. Even in a low power state, the heaters in the printhead remained operational keeping the ink hot. The ink froze when the power went out or someone shut down the printer to move or service it. Typically, this resulted in a total number of wipe cycles around 200.

To conserve energy, more stringent power saving requirements will require the printers to shut down nightly. The ink will no longer be heated and will solidify, requiring a purge and wipe cycle every morning. With an expected lifetime of 6 years, daily purges will require roughly 2000 purge and wipe cycles. Any anti-wetting coating used will have to survive this huge number of wipe cycles. These wipes can degrade the coating and cause chipping of the coating around the nozzles. This would result in lower drool pressures, which if low enough could lead to non-maintainable, non-functioning printheads.

### BRIEF DESCRIPTION OF THE DRAWINGS

FIG. 1 shows a block diagram of a solid ink printing system.

FIG. 2 shows an embodiment of a jet stack having a low adhesion, oleophobic coating.

FIG. 3 shows an alternative embodiment of a jet stack having a low adhesion, oleophobic coating.

FIG. 4 shows an embodiment of a method to operate a printer having a low adhesion, oleophobic coating.

FIG. 5 shows a graph of experimental results comparing self-cleaning with wiping.

FIG. 6 shows an embodiment of a method to coat a nozzle plate.

### DETAILED DESCRIPTION OF THE EMBODIMENTS

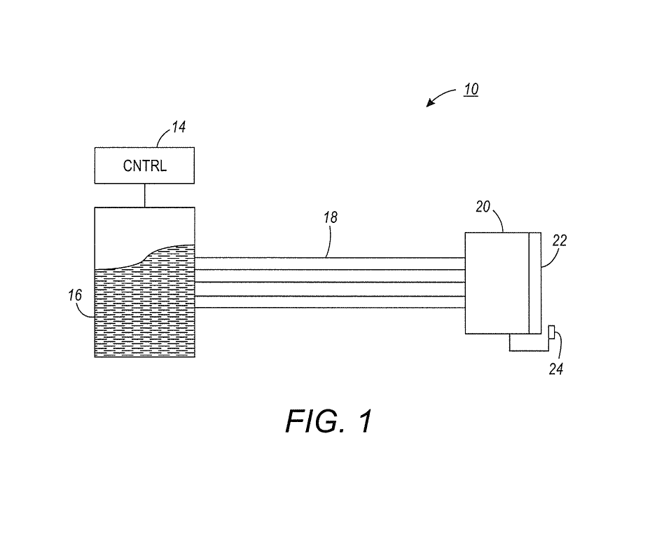

FIG. 1 shows an example of a solid ink printer 10. The solid ink 16 turns to liquid ink with heat. The controller 14 controls the heater to convert the ink and may also control the pump (not shown) that pressurizes the ink and drives it to the printhead 20 through umbilical 18. The controller 14 may control the pump, which affects the pressures at which the ink moves towards the printhead 20. It may also control the heater and the wiper 24 as well, or these may be implemented as different controllers.

The ink supply, the umbilicals and the printhead typically remained heated unless the printer powered down. This prevented the ink from solidifying and shrinking, drawing air into the ink path. However, under new energy conservation standards, the printers will typically power down each night or during long periods of idleness. This will require the system to purge itself of ink and air.

These purges may result in ink remaining on the front face of the nozzle plate 22. The nozzle plate 22 may be cleaned by a wiper assembly 24. The wiper assembly wipes the ink away from the jets or nozzles that may fail to work or work incorrectly, if blocked by ink. Ink remaining in the nozzle apertures may also result in a lower drool pressure, which is the pressure at which the ink drools out of the nozzle. Changes in the drool pressure may indicate blocked nozzles.

The wiping motion may also remove or wear down any coatings used on the front face of the nozzle plate. Coatings may allow the ink purged from the system to drain away more efficiently reducing the number of wipes needed, thereby preserving the coating for longer periods of time.

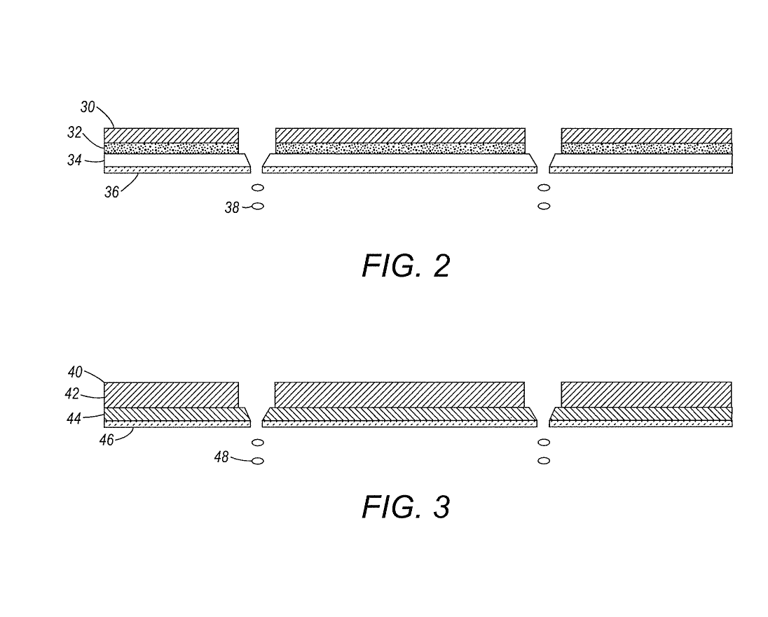

One can drastically reduce the number of wipes required to keep the front face clean using a low adhesion, oleophobic (oil-repelling) coating. FIG. 2 shows a side view of a portion of a printhead embodiment. The printhead has a jetstack. Typically, the nozzle plate would be considered part of a jetstack, but for purposes of this discussion here, the nozzle plate will be addressed separately from the rest of the jetstack. As used here, the term ‘jetstack’ refers to a stack of plates that form manifold for routing ink to pressure chambers to fill with ink and allow ink to exit the printhead through the nozzle plate.

In FIG. 2, the jetstack plates typically consisted of thin, stainless steel plates that will ultimately undergo high temperature brazing have been replaced. The plate 30 that is nearest the nozzle plate in this embodiment is an aperture plate brace. The nozzle plate 34 in this embodiment consists of a thin film, such as polyimide, to which the low adhesion, oleophobic coating is applied. The film 34 has the opening through which ink drops such as 38 exit the jetstack. The polymer film 34 attaches to the aperture plate brace 30 using an adhesive 32, such as a high temperature, thermoset adhesive. The low adhesion, oleophobic coating 36 is applied to the polymer film nozzle plate 34, typically prior to its attachment to the aperture brace, although application after attachments is certainly included in the scope.

The openings in the nozzle plate may be formed by laser ablation or other means, such as punching or cutting.

While experimental results will be discussed further for the thin, polymer film nozzle plate, one must understand that the implementation of this invention is not restricted to that particular embodiment. Current implementations of jetstacks typically consist of stacks of stainless steel plates, including the nozzle plate. FIG. 3 shows this embodiment. The jetstack 40 in this embodiment consists of a reservoir or pressure chamber plate in which the chamber that holds ink just before it is ejected resides. The nozzle plate 44 has the openings through which the ink drops such as 48 exit the jetstack. The nozzle plate 44 also has the low adhesion, oleophobic coating 46.

This coating allows for ‘self-cleaning’ of the front face of the printhead, where self-cleaning means that the printhead ink pressure is controlled to clear nozzles that have ink sitting on top of them, causing the ink to slide down the front face of the printhead. The sliding of the ink off of the front face results from the low adhesion, oleophobic coating. In one embodiment, the coating exhibits an ink contact angle of at least 45 degrees. In another embodiment, it exhibits an ink sliding angle lower than 30 degrees. The sliding angle as used here means the angle at which a sample must be tipped from horizontal for the trailing edge of a 10 microliter drop of a test fluid to start to slide. The coating may be a polymer coating, such as a polyurethane coating. In one embodiment, the coating is formed by reacting a dihydroxyl terminated perfluoropolyether oligomer or polymer with at least one isocyanate. Regardless, the coating allows the ink to slide off the front face of the printhead.

One can manipulate the pressure within the system to allow those nozzles that have ink in them to clear without causing all of the nozzles to drool. For example, one could use a printhead that has a drool pressure, which is the pressure at which the meniscus of the ink breaks and ink streams out of the nozzle, in the range of 4-7 inches of water. After drooling, the pressure is reduced to approximately 1.5″. The big drops of ink would drip of very quickly, taking with them any smaller drops in their path. Smaller drops do not slide as well because the force of gravity does not overwhelm the adhesion of the ink to the front face of the printhead, so they remain behind.

If the pressure were set to zero, those drops would stay there forever. Typically, these drops would be wiped away with a wiper blade. However, with the use of the low-adhesion coating, application of a pressure in the range of 1-2.5″ causes ink to flow out of the nozzles that have these small drops on them. The pressure lies well below the drool pressure so only these nozzles that have small drops on them will drool, as they do not have a well-defined ink meniscus fighting the drooling. The ink flows into these small drops until they grow big enough to drip away. This process is what is meant by ‘self-cleaning.’

The pressure that causes the ink drops remaining on the nozzles to clear may have any value between zero and the drool pressure of the print head. In this particular example, it ranged between 1″ and 2.5″. At 1″, the process takes much longer for the inks to grow to a size that allows them to drip away. At 2.5″, the process goes much more quickly. As long as the pressure stays below the drool pressure of the printhead, increasing the value to speed the process does not present any problems. Indeed, the self-cleaning pressure may range in value from a fraction of an inch to slightly lower than the drool pressure.

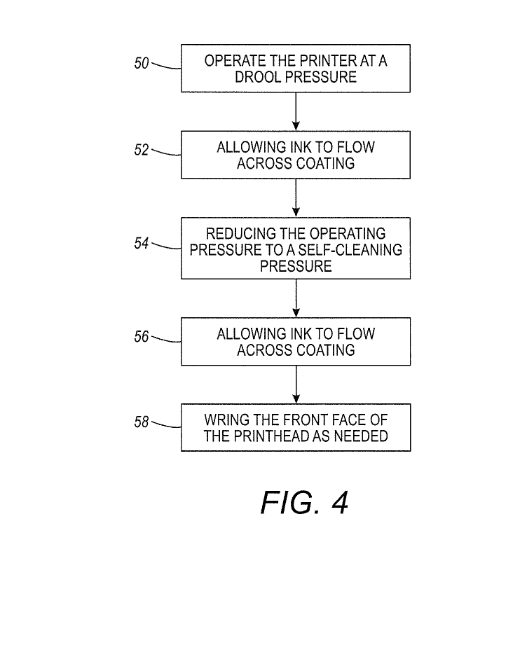

FIG. 4 shows an embodiment of the self-cleaning process. At 50, the printhead operates at the drool pressure of the printhead to allow larger drops to fill and then flow down the face of the printhead and away at 52. The pressure of the printhead, meaning the pressure applied to the ink in the printhead, reduces to the self-cleaning pressure. The specific pressure selected may depend upon the nature and type of ink, the configuration of the printhead and/or jetstack, etc. After pressure reduces to the self-cleaning pressure, it remains at that pressure for a pre-determined amount of time to allow the ink to flow across the coating at 56. Finally, if needed, the front face may undergo wiping at 58.

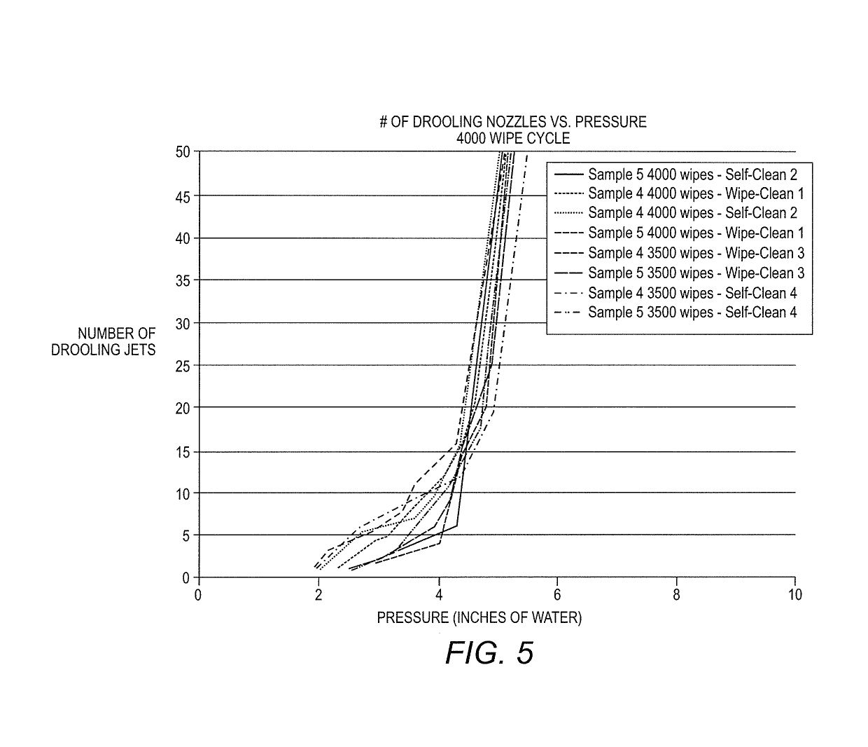

FIG. 5 shows experimental results for a self-cleaning process. Two different embodiments of the coating were used, one referred to as Sample 4, the other as Sample 5, with 4 runs performed for each run. The printhead for the experiments consisted of the thin film nozzle plate adhered to the aperture brace. The printhead consisted of 880 jetting nozzles, 112 vent holes, with 7 nozzle holes each, resulting in a total of 1664 nozzles. In the 4000 wipe cycle case, only 12 nozzles, or 0.7%, drooled at 4 inches of water applied pressure. These early drooling nozzles often result from particles built in during the builds, or other defects that a more mature manufacturing process will correct. In the graphs, ‘wipe-clean’ means that the last thing done before checking the drool pressure involved a standard wipe. ‘Self-clean’ means that no wipe occurred and the process instead allowed the ink to drip off the front face at a self-cleaning pressure.

Upon inspection, it becomes apparent that all of the curves lie very close together. This provides evidence that the drool pressure is virtually independent of whether the printhead underwent a wipe or self-cleaned, even after 4000 wipes.

In addition to this data, experiments included sprinkling the printhead with paper dust, thereby creating a dirtier print face than would typically ever exist. A moving drop of ink on the coating slid off the printhead face, even in the presence of the dust. A further benefit occurred because the ink took the paper dust with it when it slid off, meaning that a self-cleaning cycle as part of a purge would clean the printhead face similar to a wiping cycle.

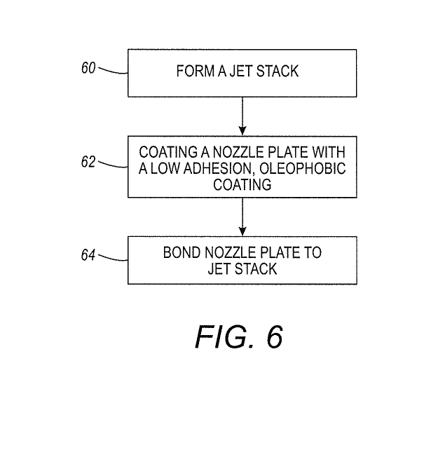

FIG. 6 shows an embodiment of a method of manufacturing such a coating. The jet stack is formed at 60, which may be one of either of the examples mentioned above, or another example. The nozzle plate receives a low adhesion, oleophobic coating at 62. The nozzle plate is then bonded to the jetstack at 64. As discussed previously, the bonding process may occur before or after the coating process, depending upon the configuration of the jetstack, the nature of the materials used in the coating, etc.

In this manner, the oleophobic, low-adhesion coatings on a printhead convert the printhead into a self-cleaning printhead. This results in a drastic reduction of wipes needed to keep the printhead running smoothly, a reduction from approximately 2000 wipe cycles to 125 wipe cycles. This also allows for particulate cleaning, such as paper dust, as well as the cleaning of any liquid contamination (such as fuser oil) that dissolves in ink, so the ink drops will clean off the oil as well.

It will be appreciated that several of the above-disclosed and other features and functions, or alternatives thereof, may be desirably combined into many other different systems or applications. Also that various presently unforeseen or unanticipated alternatives, modifications, variations, or improvements therein may be subsequently made by those skilled in the art which are also intended to be encompassed by the following claims.

What is claimed is:

1. A printhead, comprising:
a nozzle plate, having an array of nozzles through which ink is expelled;
a low adhesion, oleophobic polymer coating on a front face of the nozzle plate.

2. The printhead of claim 1, wherein the low adhesion, oleophobic coating exhibits an ink contact angle of at least 45 degrees.

3. The printhead of claim 1, wherein the low adhesion, oleophobic coating exhibits an ink sliding angle lower than 30 degrees.

4. The printhead of claim 1, wherein the nozzle plate comprises one of metal or polymer.

5. The printhead of claim 4, wherein the nozzle plate comprises stainless steel.

6. The printhead of claim 4, wherein the nozzle plate comprises polyimide.

7. The printhead of claim 6, wherein the coating comprises a polyurethane coating.

8. A printer, comprising:
a source of solid ink;
a heater arranged to heat the solid ink and convert it to liquid ink; and
a printhead, the printhead comprising:
a nozzle plate, having a plurality of nozzles through which ink is expelled;
a low adhesion, oleophobic polymer coating on a front face of the nozzle plate, the coating selected to dispel the liquid ink prior to the liquid ink returning to solid form; and
a wiper positioned to wipe the front face of the nozzle plate.

9. The printer of claim 8, wherein the printer includes a controller electrically coupled to the source of solid ink to control pressure in a flow of ink to the printhead.

10. The printer of claim 8, wherein the nozzle plate comprises a stainless steel plate.

11. The printer of claim 8, wherein the nozzle plate comprises a polyimide film.

12. The printer of claim 11, wherein the nozzle plate is bonded to an aperture brace.

13. A method of manufacturing a printhead, comprising:
forming a jetstack from a series of plates;
coating a nozzle plate with a low adhesion, oleophobic polymer coating; and
bonding the nozzle plate to the jetstack.

14. The method of claim 13, further comprising forming nozzles in the nozzle plate.

15. The method of claim 14, wherein forming nozzles in the nozzle plate comprise laser ablating the nozzles in the nozzle plate.

16. The method of claim 13, wherein coating the nozzle plate occurs after bonding the nozzle plate to the jetstack.

17. The method of claim 13, wherein bonding the nozzle plate to the jetstack further comprises bonding the nozzle plate to an aperture brace.

18. The method of claim 13, wherein bonding the nozzle plate to an aperture brace comprises using a high temperature, thermoplastic adhesive.

19. The method of claim 13, wherein coating a nozzle plate with a low adhesion, oleophobic polymer coating comprises reacting a dihydroxyl terminated perfluoropolyether oligomer or polymer with at least one isocyanate.

20. A method of cleaning a printhead, comprising:
operating the printhead at an operating pressure larger than the drool pressure for nozzles in the printhead;
allowing ink to flow across an oleophobic coating on a front face of the printhead;
reducing the operating pressure to a self-cleaning pressure; and
waiting for drops of ink that reside on selected nozzles to flow across the oleophobic coating.

21. The method of claim 20, further comprising wiping the front face of the printhead.

22. The method of claim 20, wherein operating the printhead at an operating pressure larger than the drool pressure comprises operating at a pressure in a range of 5-7 inches of water.

23. The method of claim 20, wherein reducing the operating pressure to a self-cleaning pressure comprises reducing the operating pressure in the range of a fraction of an inch of water to a pressure slightly lower than the drool pressure.
